(19) United States
(12) Patent Application Publication
(10) Pub. No.: US 2021/0102687 A1
(43) Pub. Date: Apr. 8, 2021

(54) DECORATIVE LIGHTING ATTACHMENT SYSTEM AND APPARATUS

(71) Applicant: Holiday Eaves Lighting & Accessories, LLC, Frisco, TX (US)

(72) Inventors: Stormy Brettmann-Skogg, Frisco, TX (US); Rick Skogg, Frisco, TX (US); Christian M. Castillo Pimentel, Aubrey, TX (US)

(21) Appl. No.: 17/123,721

(22) Filed: Dec. 16, 2020

Related U.S. Application Data
(63) Continuation of application No. PCT/US2018/066084, filed on Dec. 17, 2018.
(60) Provisional application No. 62/688,930, filed on Jun. 22, 2018.
(60) Provisional application No. 62/689,663, filed on Jun. 25, 2018.

(51) Int. Cl. F21V 21/088; F21S 4/10

(52) U.S. Cl. CPC F21V 21/088; F21W 2131/107; F21S 4/10

(57) ABSTRACT

A lighting attachment apparatus is provided. The lighting attachment apparatus includes a light bulb receiver coupling member. The light bulb receiver coupling member has a first arm for engaging a first side of a light bulb receiver. The light bulb receiver coupling member also has a first set of teeth disposed on an end of the first arm. The light bulb receiver coupling member further has a second arm for engaging a second side of the light bulb receiver opposite the first side of the light bulb receiver. In addition, the light bulb receiver coupling member has a second set of teeth disposed on an end of the second arm and for engaging with the first set of teeth to secure the first arm against the first side of the light bulb receiver and the second arm against the second side of the light bulb receiver.

### CROSS-REFERENCE TO RELATED APPLICATIONS

This is a continuation of International Patent Application PCT/US2018/066084, filed Dec. 17, 2018, and claims the benefit of the filing dates of U.S. Provisional Patent Applications 62/688,930, filed Jun. 22, 2018 and 62/689,663, filed Jun. 25, 2018, all of which are hereby incorporated by reference.

### TECHNICAL FIELD

This disclosure is generally directed to decorative lighting. More specifically, this disclosure is directed to a system and an apparatus to display decorative lighting.

### BACKGROUND

For a multitude of occasions, decorative lighting is displayed on buildings, rooftops, shingles, rain gutters, and the like. Often because much decorative lighting is seasonal, decorative lighting is displayed for a period of time commemorating an occasion and taken down. Subsequently, new or different decorative lighting is displayed for the next occasion for a period of time and taken down. The process of displaying decorative lighting and removing decorative lighting can be time consuming and expensive.

### SUMMARY

This disclosure provides decorative lighting attachment apparatuses and systems.

In a first embodiment, a lighting attachment apparatus is provided. The lighting attachment apparatus includes a body having a proximal end and a distal end. The lighting attachment apparatus also includes an attachment member disposed at the proximal end of the body for removably attaching the body to a structure. The lighting attachment apparatus further includes a light bulb receiver coupling member disposed at the distal end of the body. The light bulb receiver coupling member has a first arm for engaging a first side of a light bulb receiver. The light bulb receiver coupling member also has a first set of teeth disposed on an end of the first arm. The light bulb receiver coupling member further has a second arm for engaging a second side of the light bulb receiver opposite the first side of the light bulb receiver. In addition, the light bulb receiver coupling member has a second set of teeth disposed on an end of the second arm and for engaging with the first set of teeth to secure the first arm against the first side of the light bulb receiver and the second arm against the second side of the light bulb receiver.

In a second embodiment, a lighting attachment apparatus is provided. The lighting attachment apparatus includes a light bulb receiver coupling member. The light bulb receiver coupling member has a first arm for engaging a first side of a light bulb receiver. The light bulb receiver coupling member also has a first set of teeth disposed on an end of the first arm. The light bulb receiver coupling member further has a second arm for engaging a second side of the light bulb receiver opposite the first side of the light bulb receiver. In addition, the light bulb receiver coupling member has a second set of teeth disposed on an end of the second arm and for engaging with the first set of teeth to secure the first arm against the first side of the light bulb receiver and the second arm against the second side of the light bulb receiver.

In a third embodiment, a lighting attachment apparatus is provided. The lighting attachment apparatus includes a body having a proximal end and a distal end. The lighting attachment apparatus also includes an attachment member disposed at the proximal end of the body for removably attaching the body to a structure. The lighting attachment apparatus further includes a light bulb receiver configured to receive a light bulb for illumination. In addition, the lighting attachment apparatus includes a light bulb receiver coupling member disposed at the distal end of the body. The light bulb receiver coupling member has a first arm for engaging a first side of a light bulb receiver. The light bulb receiver coupling member also has a first set of teeth disposed on an end of the first arm. The light bulb receiver coupling member further has a second arm for engaging a second side of the light bulb receiver opposite the first side of the light bulb receiver. In addition, the light bulb receiver coupling member has a second set of teeth disposed on an end of the second arm and for engaging with the first set of teeth to secure the first arm against the first side of the light bulb receiver and the second arm against the second side of the light bulb receiver.

Other technical features may be readily apparent to one skilled in the art from the following figures, descriptions, and claims.

Definitions for various words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates a perspective view of an example lighting attachment apparatus in accordance with various embodiments of the present disclosure;

FIG. 2 illustrates a top perspective view of an example lighting attachment apparatus in accordance with various embodiments of the present disclosure;

FIG. 3 illustrates a perspective view of an example lighting attachment system in accordance with various embodiments of the present disclosure;

FIG. 4 illustrates a perspective view of an example lighting attachment apparatus in accordance with various embodiments of the present disclosure;

FIG. 5 illustrate a profile view of an example lighting attachment apparatus in accordance with various embodiments of the present disclosure;

FIG. 6 illustrates an end view of an example lighting attachment apparatus in accordance with various embodiments of the present disclosure;

FIG. 7 illustrates another end view of an example lighting attachment apparatus in accordance with various embodiments of the present disclosure;

FIG. 8 illustrates a side perspective view of an example lighting attachment apparatus in accordance with various embodiments of the present disclosure;

FIG. 9 illustrates a perspective view of an example light bulb receiver coupling member of a lighting attachment apparatus in accordance with various embodiments of the present disclosure;

FIG. 10 illustrates a perspective view of another light bulb receiver coupling member of a lighting attachment apparatus in accordance with various embodiments of the present disclosure; and

FIG. 11 illustrates a perspective view of another lighting attachment apparatus in accordance with various embodiments of the present disclosure.

### DETAILED DESCRIPTION

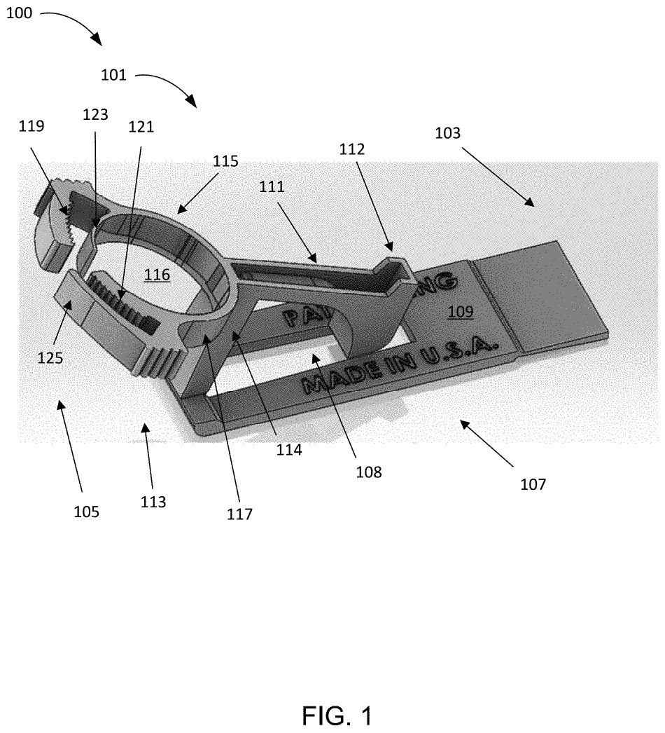

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of this disclosure may be implemented in any suitably arranged device or system.

For a multitude of occasions, decorative lighting is displayed on buildings, rooftops, shingles, rain gutters, and the like. Often because much decorative lighting is seasonal, decorative lighting is displayed for a period of time commemorating an occasion and taken down. Subsequently, new or different decorative lighting is displayed for the next occasion for a period of time and taken down. The process of displaying decorative lighting and removing decorative lighting can be time consuming and expensive.

For example, when decorative lighting is placed on a structure for display, initially, traditional lighting attachment devices (e.g., a hook, a nail) may be strategically placed at locations on a structure. Afterwards, decorative lighting may be placed for display using the traditional lighting attachment devices to maintain the planned lighting arrangement. Thus, displaying decorative lighting may require at least two steps: (1) securing the traditional lighting attachment devices to the structure; and (2) displaying the decorative lights on the structure using the nails and the hooks.

Further, when the decorative lighting is to be taken down, the decorative lighting may first be removed. In this case, an extension pole and hook may be used to reach the wiring of the decorative lighting. The extension pole and hook may pull the wiring to take down the lighting. However, the extension pole and hook may be unable to also remove the traditional lighting attachment devices that detached from the lighting and thus remain secured to the structure. Accordingly, each of the remaining traditional lighting attachment devices may be manually removed from the structure (often with the use of a ladder). Thus, removing decorative lighting may require at least two steps: (1) removing the decorative lighting from the structure; and (2) removing the remaining traditional lighting attachment devices from the structure.

In addition, after decorative lighting is placed on a structure for display, the decorative lighting may be moved or further arranged to the satisfaction of the viewer. Thus, the decorative lighting may be pulled down as described above followed by the remaining traditional lighting attachment devices so that the traditional lighting attachment devices may be repositioned and secured to the structure to accommodate the new arrangement. Subsequently, the decorative lighting may be redisplayed in the new arrangement using the traditional lighting attachment devices.

Traditional lighting attachment devices may only attach to one of a roof shingle or a building rain gutter. Further, traditional lighting attachment devices may be permanently attached to the light bulb receiver and thus may be unable to be removed from a light bulb receiver and subsequently reattached to a light bulb receive. In addition, traditional lighting attachments may allow a light bulb receiver to easily break away from the traditional lighting attachment device during removal of the light bulb receiver from a roof shingle or a building rain gutter. Thus, the traditional lighting attachment device may require a light bulb hanging or removing worker to retrieve the individual traditional lighting attachment devices after the light bulb receiver is removed.

This disclosure provides a lighting attachment apparatus and system that securely fastens to a light bulb receiver while being capable of coupling a light bulb receiver to a structure (e.g., a roof shingle, a building rain gutter). Thus, each of the light bulb receivers of the decorative lighting may be attached to a lighting attachment apparatus before being positioned for display on a structure. Both the lighting attachment apparatus and the light bulb receiver of decorative lighting may be positioned on a structure or moved from one position on a structure to another in single steps. Subsequently, each of the light bulb receivers of the decorative lighting and their attached lighting attachment apparatuses may be removed from a structure in a single step using, for example, an extension pole and hook. As used throughout this specification, the term light bulb receiver may be any receiver that may receive a light bulb for light bulb illumination. Light bulb receivers may be associated with strand lighting (e.g., holiday outdoor lighting), spot lighting, portable lighting devices, or the like.

FIG. 1 illustrates a perspective view of an example lighting attachment apparatus 100 in accordance with various embodiments of the present disclosure. The lighting attachment apparatus 100 may be for coupling a light bulb receiver to a structure (e.g., a building, a tent, a stand, a handheld object). For example, the lighting attachment apparatus 100 may secure a light bulb receiver of a plurality of light bulb receivers coupled along a chain or a strand of electrical wiring to a roof line, on a roof, or along a rain gutter of a structure for Christmas or holiday lighting. As another example, the lighting attachment apparatus 100 may secure a single light bulb receiver (e.g., a flashlight body) to a location on a tent to provide temporary lighting within or near the tent. As yet another example, the lighting attachment apparatus 100 may secure a light bulb receiver to a camera or a stand to provide moveable lighting for photography or a display. The lighting attachment apparatus 100 may include one or more components made of a flexible elastic plastic, metal, composite, or the like.

As shown in FIG. 1, the lighting attachment apparatus 100 may generally include a body 101 having a proximal end 103 and a distal end 105. The body 101 may generally have an elongated shape with the proximal end 103 and the distal end 105 positioned 180 degrees from each other about an axis. The elongated shape of the body 101 may also have a first distance from the proximal end 103 to the distal end 105 of the body 101 is greater than a second distance across the body 101 that is perpendicular to the first distance providing the body 101 with the elongated shape.

An attachment member 107 may be disposed at the proximal end 103 of the body 101. The attachment member 107 may be for attaching the body 101 to a structure (e.g., a building, a tent, a stand, a handheld object) to maintain a position or an orientation of the lighting attachment apparatus 100. In certain embodiments, the attachment member 107 may include an elongated member 109. The elongated member 109 may be inserted against a surface or between two surfaces to maintain the body 101 in a position or an orientation. For example, the elongated member 109 may be positioned between two anchored walls and provide a force against a surface of each of the two anchored wall so that the attachment member 107 maintains a position or an orientation of the lighting attachment apparatus 100. In certain embodiments, the elongated member 109 may be a flat elongated member or a have at least a portion of a length that is flat. In this case, the elongated member 109 may be inserted between two narrowly-spaced structures or between to roof shingles to maintain the body 101 in a position or an orientation.

In certain embodiments, the attachment member 107 may include an attachment arm 111 having an end 112 of the attachment arm 111 (e.g., opposite the distal end 105 of the body 101). The end 112 may include a hook and the attachment arm 111 may extend so that the hook at the end 112 of the attachment arm 111 may wrap around or over a lip, a ledge, or an attachment point (e.g., a rope, a string, a loop) of a structure to hang or maintain the body 101 in a position or an orientation. The hook may include one turning point, two turning points, or a plurality of turning points to hook the attachment member 107 over a lip, a ledge, or an attachment point of a structure. Additionally, or alternatively, the hook may be rounded to hook the attachment member 107 over a lip, a ledge, or an attachment point of a structure.

In certain embodiments, the attachment member 107 may include both the elongated member 109 and the attachment arm 111. The elongated member 109 may include an aperture 108 providing a through-hole through at least a portion of the elongated member 109. The attachment arm 111 may be a flexible clamp so that in a resting position the end 112 may extend at least partially into or partially through the aperture 108. The end 112 of the flexible clamp may be moved into a tension position out of the aperture 108 and away from the elongated member 109 providing a gap between the end 112 of the flexible clamp (e.g., and a portion of the length of the flexible clamp) and the elongated member 109. A wall of a structure (e.g., a wall of a rain gutter) or a roof shingle may be inserted into the gap between the elongated member 109 and the flexible clamp. The flexible clamp may be released from the tension position allowing the flexible clamp to return to the resting position so that the end 112 of the flexible clamp (e.g., and a portion of the length of the flexible clamp) engages the wall of the structure or the roof shingle to exert a clasping force on the wall of the structure or the roof shingle and the elongated member 109 by the flexible clamp.

In certain embodiments, an elevation arm 114 may be fixedly attached to the elongated member 109 and the attachment arm 111. The elevation arm 114 may extend at an angle from the elongated member 109 and allow the attachment arm 111 to flex or move when the attachment arm is a flexible clamp. In some embodiments, as illustrated in FIG. 1, a light bulb receiver coupling member 113 may be attached to an end of the attachment arm 111 that is opposite the end 112 of the attachment arm 111. The elevation arm 114 extending from the elongated member 109 may be attached to a light bulb receiver coupling member 113 to cause a light bulb within a light bulb receiver that is attached to the light bulb receiver coupling member 113 to extend out from the body 101 increasing the visibility and access to the light bulb when decorative lighting is displayed. The elevation arm 114 may also extend from the elongated member 109 and be attached to the light bulb receiver coupling member 113 to provide additional space for an end of a light bulb receiver or additional space for a light bulb when the elongated member 109 is mounted flush against a surface.

As described herein, the lighting attachment apparatus 100 also includes a light bulb receiver coupling member 113. A light bulb receiver may be a light bulb socket or a housing of a light bulb socket that secures a light bulb and couples the light bulb to an electrical power source to illuminate the light bulb. The light bulb receiver coupling member 113 may be disposed at the distal end 105 of the body 101 of the lighting attachment apparatus 100. The light bulb receiver coupling member 113 may engage with and attach a light bulb receiver to the lighting attachment apparatus 100. In certain embodiments, the light bulb receiver coupling member 113 may include a pair of straps having VELCRO, a pair of straps with one strap having a button or pin and the other strap having one or more holes to receive the button or pin, or the like.

In certain embodiments, the light bulb receiver coupling member 113 may include a first arm 115 and a second arm 117 that each extend from the attachment member 107. The first arm 115 and the second arm 117 may be positioned so that a gap 116 is formed between them. Each of the first arm 115 and the second arm 117 may be moved or flexed from a resting position toward each other into a tension position. In certain embodiments, the first arm 115 may be moved from the resting position to engage a first surface of the light bulb receiver and the second arm 117 may be moved from the resting position to engage a second surface of the light bulb receiver opposite the first surface of the light bulb receiver.

A first set of teeth 119 may be disposed along a length of a surface at an end of the first arm 115. A second set of teeth 121 may be disposed along a length of a surface at an end of the second arm 117. The first arm 115 and the second arm 117 may each have a turning point so that the end of the first arm 115 having the first set of teeth 119 and the end of the second arm 117 have the second set of teeth 121 extend toward each other. In certain embodiments, the first arm 115 and the second arm 117 may each have a curvature so that the end of the first arm 115 having the first set of teeth 119 and the end of the second arm 117 have the second set of teeth 121 extend toward each other.

When the first arm 115 and the second arm 117 are moved from the resting positions towards the tension positions, the first set of teeth 119 may engage the second set of teeth 121 to hold the first arm 115 and the second arm 117 in tension positions. For example, the first arm 115 and the second arm 117 may be moved from the resting positions towards the tension positions so that a first tooth of the first set of teeth 119 cinches or ratchets over and engages a first tooth of the second set of teeth 121 to hold the first arm 115 and the second arm 117 in a first tension position. In another example, the first arm 115 and the second arm 117 may be further moved away from the resting positions and towards the tension positions so that two or more teeth of the first set of teeth 119 may cinch or ratchet over and engage two or more teeth of the second set of teeth 121 to hold the first arm 115 and the second arm 117 in multiple different tension positions and to maintain different distances between the first arm 115 and the second arm 117. Thus, the light bulb receiver coupling member 113 may couple different light bulb receivers having different thicknesses or diameters to the body 101 of the lighting attachment apparatus 100 by adjusting the number of teeth from the first set of teeth 119 that cinch or ratchet over and engage teeth from the second set of teeth 121 and varying the size, diameter, or distance of the gap 116. In addition, the first arm 115 and the second arm 117 may apply greater amounts of force to the first surface of the light bulb receiver and the second surface of the light bulb receiver, respectively, by adjusting the number of teeth from the first set of teeth 119 that cinch or ratchet over and engage teeth from the second set of teeth 121.

In certain embodiments, each of the one or more teeth from the first set of teeth 119 and each of the one or more teeth from the second set of teeth 121 may be shaped or angled. The shape or angle of each of the teeth may permit a tooth from the first set of teeth 119 to cinch or ratchet over and engage a tooth from the second set of teeth 121 when the first arm 115 and the second arm 117 move away from the resting positions towards tension positions (e.g., when the end of the first arm 115 moves towards the end of the second arm 117). Conversely, the shape or angle of each of the teeth may prevent a tooth from the first set of teeth 119 from cinching or ratcheting over a tooth from the second set of teeth 121 and may prevent disengagement of the first set of teeth 119 from the second set of teeth 121 when a force is exerted on the first arm 115 or the second arm 117 towards the resting positions. Thus, in certain embodiments, the first arm 115 or the second arm 117 may be misaligned from the other or moved so that peaks of one or more teeth from the first set of teeth 119 slide along or through troughs of one or more teeth from the second set of teeth 121 and peaks of one or more teeth from the second set of teeth 121 slide along or through troughs of one or more teeth from the first set of teeth 119 to release engagement between the first set of teeth 119 and the second set of teeth 121. Upon release of engagement between the first set of teeth 119 and the second set of teeth 121, the first arm 115 and the second arm 117 may each return to their respective resting positions.

In certain embodiments, the first arm 115 may include a first tooth clamp 123 and the second arm 117 may include a second tooth clamp 125. When one or more teeth of the first set of teeth 119 cinch or ratchet over and engage one or more teeth of the second set of teeth 121, the first tooth clamp 123 engages a surface of the second arm 117 that is opposite from the second set of teeth 121 for forcing the one or more teeth from the second set of teeth 121 against the one or more teeth from the first set of teeth 119. Similarly, when one or more teeth of the first set of teeth 119 cinch or ratchet over and engage one or more teeth of the second set of teeth 121, the second tooth clamp 125 engages a surface of the first arm 115 that is opposite from the first set of teeth 119 for forcing the one or more teeth from the first set of teeth 119 against the one or more teeth from the second set of teeth 121. The first tooth clamp 123 and the second tooth clamp 125 may each further prevent disengagement of the first set of teeth 119 from the second set of teeth 121 when a force is exerted on the first arm 115 or the second arm 117 towards the resting positions.

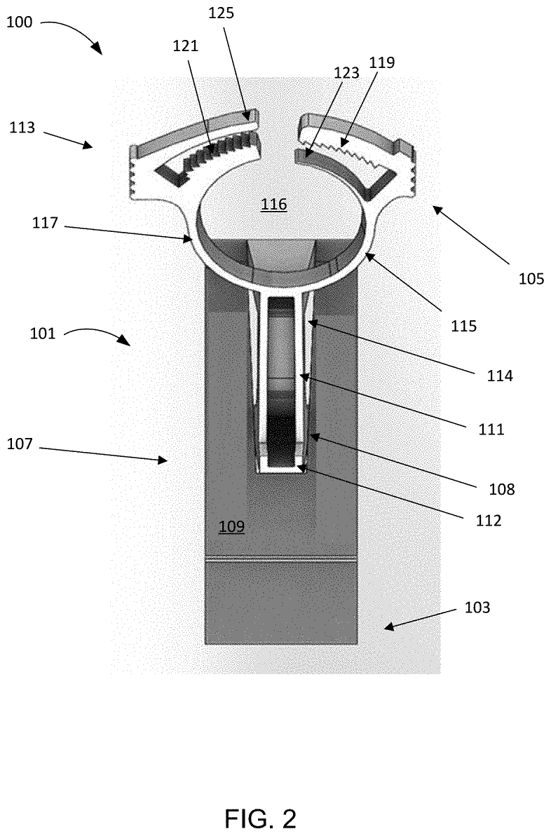

FIG. 2 illustrates a top perspective view of an example lighting attachment apparatus 100 in accordance with various embodiments of the present disclosure. As shown in FIG. 2, the lighting attachment apparatus 100 may include one or more same or similar features described with respect to FIG. 1. As shown in FIG. 2, the first arm 115 and the second arm 117 of the light bulb receiver coupling member 113 are positioned in a resting position. In the resting positions, the end of the first arm 115 is extending towards the end of the second arm 117. However, in the resting positions, the end of the first arm 115 does not engage the end of the second arm 117 and thus, the first set of teeth 119 is not able to cinch or ratchet over and engage the second set of teeth 121. In certain embodiments, each of the first arm 115 and the second arm 117 may be moved or flexed to another tension position away from the resting positions to further separate the distance between the end of the first arm 115 and the end of the second arm 117 so as to move a light bulb receiver through a gap between the end of the first arm 115 and the end of the second arm 117 to position the light bulb receiver within the gap 116. After the first arm 115 and the second arm 117 are released from the other tension positions, the first arm 115 and the second arm 117 may return to the resting positions so that the light bulb receiver may not pass through the gap between the end of the first arm 115 and the end of the second arm 117. Subsequently, the first arm 115 and the second arm 117 may be moved or flexed into the tension positions moving the end of the first arm 115 towards the end of the second arm 117 so that the first set of teeth 119 may cinch or ratchet over and engage the second set of teeth 121 to secure the light bulb receiver within the gap 116.

The light bulb receiver coupling member 113 may allow for a secure hold on a light bulb receiver so that when decorative lighting is pulled from a structure (e.g., using an extension pole and hook), the light bulb receivers of the decorative lighting and each of the attached lighting attachment apparatuses 100 may be pulled and removed together reducing or eliminating the otherwise extra step of separately retrieving the lighting attachment apparatuses 100 either from the structure or from the ground next to the structure. In addition, the light bulb receiver coupling member 113 allows for the manual detachment of a light bulb receiver without damaging either the lighting attachment apparatus 100 or the light bulb receiver. Accordingly, a light bulb receiver (e.g., another light bulb receiver) may be attached to a lighting attachment apparatus 100 via the light bulb receiver coupling member 113 after a light bulb receiver is detached from the lighting attachment apparatus 100.

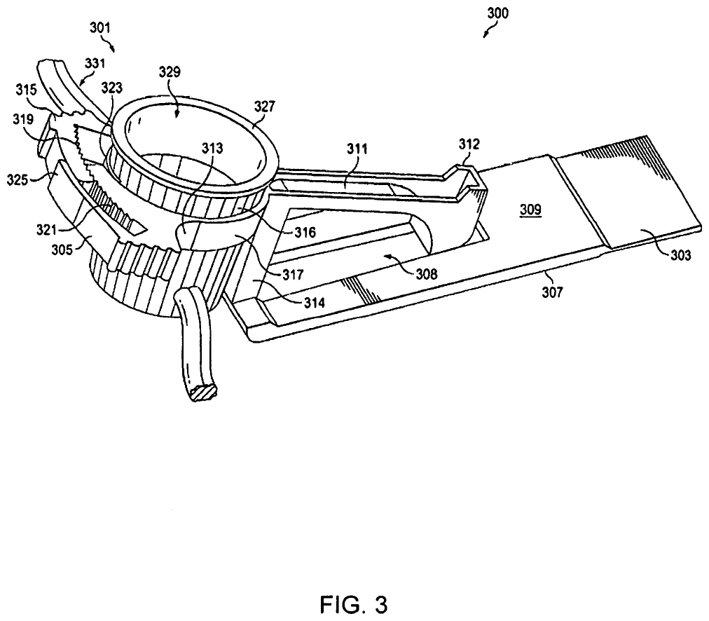

FIG. 3 illustrates a perspective view of an example lighting attachment system 300 in accordance with various embodiments of the present disclosure. The lighting attachment system 300 may include one or more same or similar features of the lighting attachment apparatus 100 illustrated in FIGS. 1 and 2. The lighting attachment system 300 may be for coupling a light bulb receiver to a structure (e.g., a building, a tent, a stand, a handheld object). For example, the lighting attachment system 300 may secure a light bulb receiver of a plurality of light bulb receivers coupled along a chain or a strand of electrical wiring to a roof line, on a roof, or along a rain gutter of a structure for Christmas or holiday lighting. As another example, the lighting attachment system 300 may secure a single light bulb receiver (e.g., a flashlight body) to a location on a tent to provide temporary lighting within or near the tent. As yet another example, the lighting attachment system 300 may secure a light bulb receiver to a camera or a stand to provide moveable lighting for photography or a display.

As shown in FIG. 3, the lighting attachment system 300 may generally include a body 301 having a proximal end 303 and a distal end 305. The body 301 may generally have an elongated shape with the proximal end 303 and the distal end 305 positioned 180 degrees from each other about an axis. The elongated shape of the body 301 may also have a first distance from the proximal end 303 to the distal end 305 of the body 301 is greater than a second distance across the body 301 that is perpendicular to the first distance providing the body 301 with the elongated shape. The lighting attachment system 300 may include one or more components made of a flexible elastic plastic, metal, composite, or the like.

An attachment member 307 may be disposed at the proximal end 303 of the body 301. The attachment member 307 may be for attaching the body 301 to a structure (e.g., a building, a tent, a stand, a handheld object) to maintain a position or an orientation of the lighting attachment system 300. In certain embodiments, the attachment member 307 may include an elongated member 309. The elongated member 309 may be inserted against a surface or between two surfaces to maintain the body 301 in a position or an orientation. For example, the elongated member 309 may be positioned between two anchored walls and provide a force against a surface of each of the two anchored wall so that the attachment member 307 maintains a position or an orientation of the lighting attachment system 300. In certain embodiments, the elongated member 309 may be a flat elongated member or a have at least a portion of a length that is flat. In this case, the elongated member 309 may be inserted between two narrowly-spaced structures or between to roof shingles to maintain the body 301 in a position or an orientation.

In certain embodiments, the attachment member 307 may include an attachment arm 311 having an end 312 of the attachment arm 311 (e.g., opposite the distal end 305 of the body 301). The end 312 may include a hook and the attachment arm 311 may extend so that the hook at the end 312 of the attachment arm 311 may wrap around or over a lip, a ledge, or an attachment point (e.g., a rope, a string, a loop) of a structure to hang or maintain the body 301 in a position or an orientation. The hook may include one turning point, two turning points, or a plurality of turning points to hook the attachment member 307 over a lip, a ledge, or an attachment point of a structure. Additionally, or alternatively, the hook may be rounded to hook the attachment member 307 over a lip, a ledge, or an attachment point of a structure.

In certain embodiments, the attachment member 307 may include both the elongated member 309 and the attachment arm 311. The elongated member 309 may include an aperture 308 providing a through-hole through at least a portion of the elongated member 309. The attachment arm 311 may be a flexible clamp so that in a resting position the end 312 may extend at least partially into or partially through the aperture 308. The end 312 of the flexible clamp may be moved into a tension position out of the aperture 308 and away from the elongated member 309 providing a gap between the end 312 of the flexible clamp (e.g., and a portion of the length of the flexible clamp) and the elongated member 309. A wall of a structure (e.g., a wall of a rain gutter) or a roof shingle may be inserted into the gap between the elongated member 309 and the flexible clamp. The flexible clamp may be released from the tension position allowing the flexible clamp to return to the resting position so that the end 312 of the flexible clamp (e.g., and a portion of the length of the flexible clamp) engages the wall of the structure or the roof shingle to exert a clasping force on the wall of the structure or the roof shingle and the elongated member 309 by the flexible clamp.

In certain embodiments, an elevation arm 314 may be fixedly attached to the elongated member 309 and the attachment arm 311. The elevation arm 314 may extend at an angle from the elongated member 309 and allow the attachment arm 311 to flex or move when the attachment arm is a flexible clamp. In some embodiments, as illustrated in FIG. 3, a light bulb receiver coupling member 313 may be attached to an end of the attachment arm 311 that is opposite the end 312 of the attachment arm 311. The elevation arm 314 extending from the elongated member 309 may be attached to a light bulb receiver coupling member 313 to cause a light bulb within a light bulb receiver that is attached to the light bulb receiver coupling member 313 to extend out from the body 301 increasing the visibility and access to the light bulb when decorative lighting is displayed. The elevation arm 314 may also extend from the elongated member 309 and be attached to the light bulb receiver coupling member 313 to provide additional space for an end of a light bulb receiver or additional space for a light bulb when the elongated member 309 is mounted flush against a surface.

As described herein, the lighting attachment system 300 also includes a light bulb receiver coupling member 313. A light bulb receiver may be a light bulb socket or a housing of a light bulb socket that secures a light bulb and couples the light bulb to an electrical power source to illuminate the light bulb. The light bulb receiver coupling member 313 may be disposed at the distal end 305 of the body 301 of the lighting attachment system 300. The light bulb receiver coupling member 313 may engage with and attach a light bulb receiver to the lighting attachment system 300. In certain embodiments, the light bulb receiver coupling member 313 may include a pair of straps having VELCRO, a pair of straps with one strap having a button or pin and the other strap having one or more holes to receive the button or pin, or the like.

In certain embodiments, the light bulb receiver coupling member 313 may include a first arm 315 and a second arm 317 that each extend from the attachment member 307. The first arm 315 and the second arm 317 may be positioned so that a gap 316 is formed between them. Each of the first arm 315 and the second arm 317 may be moved or flexed from a resting position toward each other into a tension position. In certain embodiments, the first arm 315 may be moved from the resting position to engage a first surface of the light bulb receiver and the second arm 317 may be moved from the resting position to engage a second surface of the light bulb receiver opposite the first surface of the light bulb receiver.

A first set of teeth 319 may be disposed along a length of a surface at an end of the first arm 315. A second set of teeth 321 may be disposed along a length of a surface at an end of the second arm 317. The first arm 315 and the second arm 317 may each have a turning point so that the end of the first arm 315 having the first set of teeth 319 and the end of the second arm 317 have the second set of teeth 321 extend toward each other. In certain embodiments, the first arm 315 and the second arm 317 may each have a curvature so that the end of the first arm 315 having the first set of teeth 319 and the end of the second arm 317 have the second set of teeth 321 extend toward each other.

When the first arm 315 and the second arm 317 are moved from the resting positions towards the tension positions, the first set of teeth 319 may engage the second set of teeth 321 to hold the first arm 315 and the second arm 317 in tension positions. For example, the first arm 315 and the second arm 317 may be moved from the resting positions towards the tension positions so that a first tooth of the first set of teeth 319 cinches or ratchets over and engages a first tooth of the second set of teeth 321 to hold the first arm 315 and the second arm 317 in a first tension position. In another example, the first arm 315 and the second arm 317 may be further moved away from the resting positions and towards the tension positions so that two or more teeth of the first set of teeth 319 may cinch or ratchet over and engage two or more teeth of the second set of teeth 321 to hold the first arm 315 and the second arm 317 in multiple different tension positions and to maintain different distances between the first arm 315 and the second arm 317. Thus, the light bulb receiver coupling member 313 may couple different light bulb receivers having different thicknesses or diameters to the body 301 of the lighting attachment system 300 by adjusting the number of teeth from the first set of teeth 319 that cinch or ratchet over and engage teeth from the second set of teeth 321 and varying the size, diameter, or distance of the gap 316. In addition, the first arm 315 and the second arm 317 may apply greater amounts of force to the first surface of the light bulb receiver and the second surface of the light bulb receiver, respectively, by adjusting the number of teeth from the first set of teeth 319 that cinch or ratchet over and engage teeth from the second set of teeth 321.

In certain embodiments, each of the one or more teeth from the first set of teeth 319 and each of the one or more teeth from the second set of teeth 321 may be shaped or angled. The shape or angle of each of the teeth may permit a tooth from the first set of teeth 319 to cinch ratchet over and engage a tooth from the second set of teeth 321 when the first arm 315 and the second arm 317 move away from the resting positions towards tension positions (e.g., when the end of the first arm 315 moves towards the end of the second arm 317). Conversely, the shape or angle of each of the teeth may prevent a tooth from the first set of teeth 319 from cinching or ratcheting over a tooth from the second set of teeth 321 and may prevent disengagement of the first set of teeth 319 from the second set of teeth 321 when a force is exerted on the first arm 315 or the second arm 317 towards the resting positions. Thus, in certain embodiments, the first arm 315 or the second arm 317 may be misaligned from the other or moved so that peaks of one or more teeth from the first set of teeth 319 slide along or through troughs of one or more teeth from the second set of teeth 321 and peaks of one or more teeth from the second set of teeth 321 slide along or through troughs of one or more teeth from the first set of teeth 319 to release engagement between the first set of teeth 319 and the second set of teeth 321. Upon release of engagement between the first set of teeth 319 and the second set of teeth 321, the first arm 315 and the second arm 317 may each return to their respective resting positions.

In certain embodiments, the first arm 315 may include a first tooth clamp 323 and the second arm 317 may include a second tooth clamp 325. When one or more teeth of the first set of teeth 319 cinch or ratchet over and engage one or more teeth of the second set of teeth 321, the first tooth clamp 323 engages a surface of the second arm 317 that is opposite from the second set of teeth 321 for forcing the one or more teeth from the second set of teeth 321 against the one or more teeth from the first set of teeth 319. Similarly, when one or more teeth of the first set of teeth 319 cinch or ratchet over and engage one or more teeth of the second set of teeth 321, the second tooth clamp 325 engages a surface of the first arm 315 that is opposite from the first set of teeth 319 for forcing the one or more teeth from the first set of teeth 319 against the one or more teeth from the second set of teeth 321. The first tooth clamp 323 and the second tooth clamp 325 may each further prevent disengagement of the first set of teeth 319 from the second set of teeth 321 when a force is exerted on the first arm 315 or the second arm 317 towards the resting positions.

The lighting attachment system 300 also includes a light bulb receiver 327. As shown in FIG. 3, the light bulb receiver 327 is positioned between the first arm 315 and the second arm 317 within the gap 316. The light bulb receiver 327 may retain a light bulb for illumination. In certain embodiments, the light bulb receiver 327 may include an aperture 329 for receiving a light bulb or electrically connecting the light bulb to a power source for illumination. In certain embodiments, the light bulb receiver 327 may also include a cord 331 (e.g., a wired connection, a wired strand, a line, a string) that connects the light bulb receiver 327 to one or more other light bulb receivers or provides an electrical connection between the light bulb receiver 327 and a power source to illuminate a light bulb retained by the light bulb receiver 327.

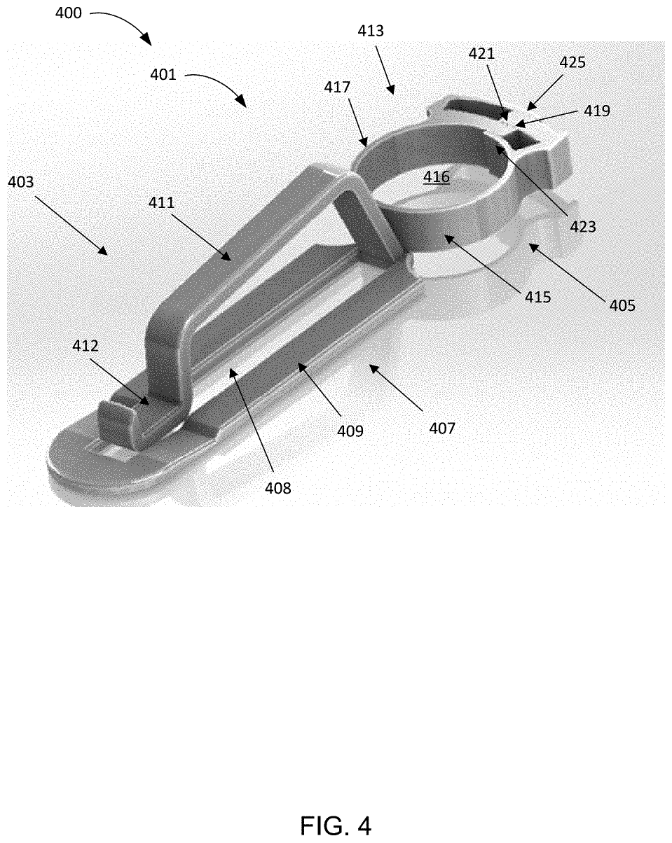

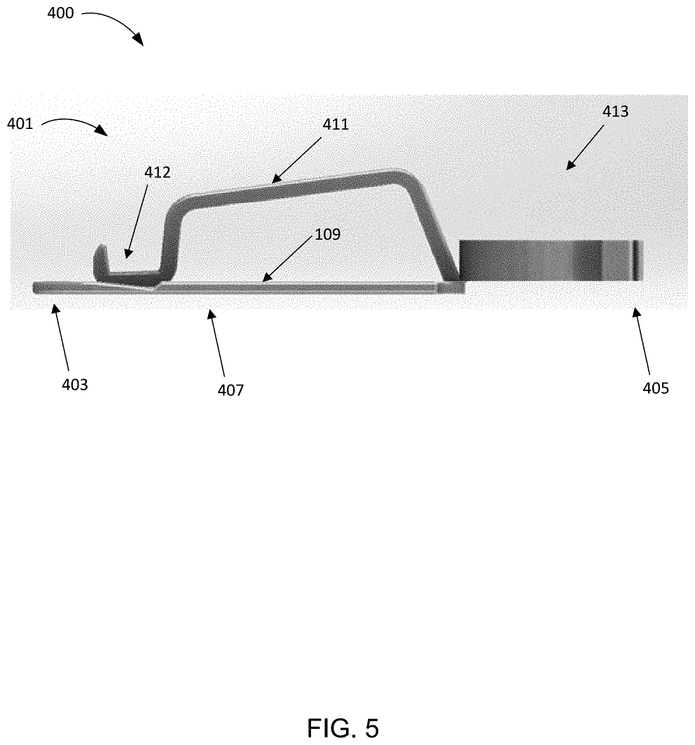

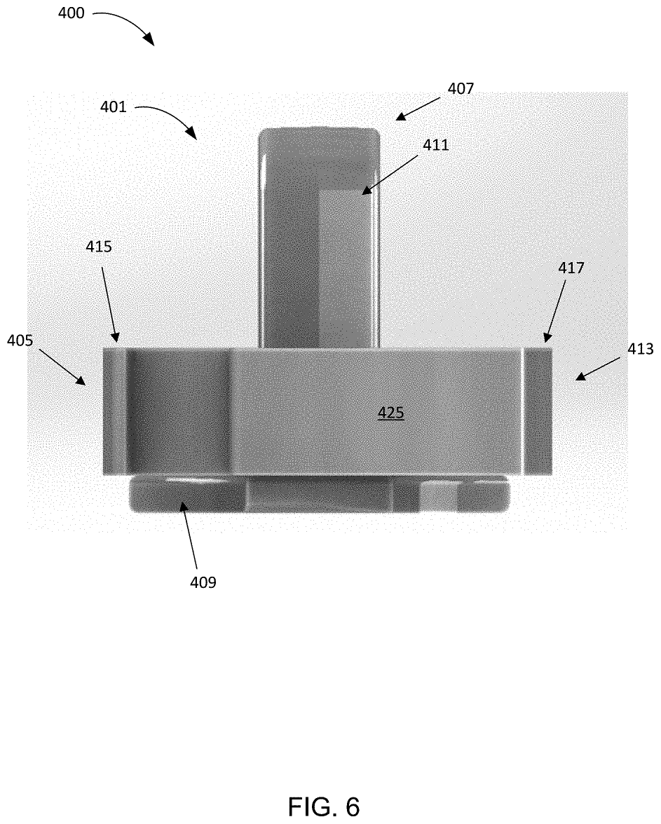

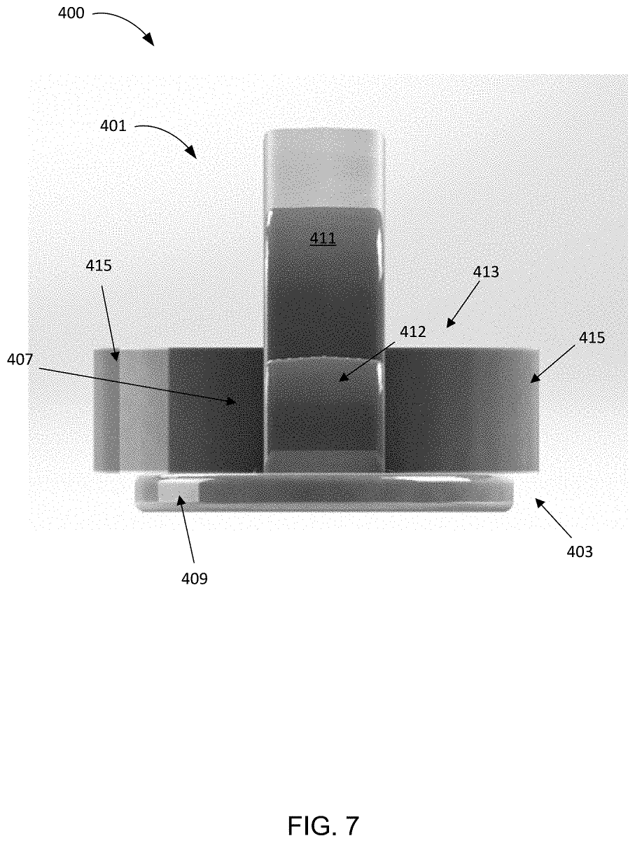

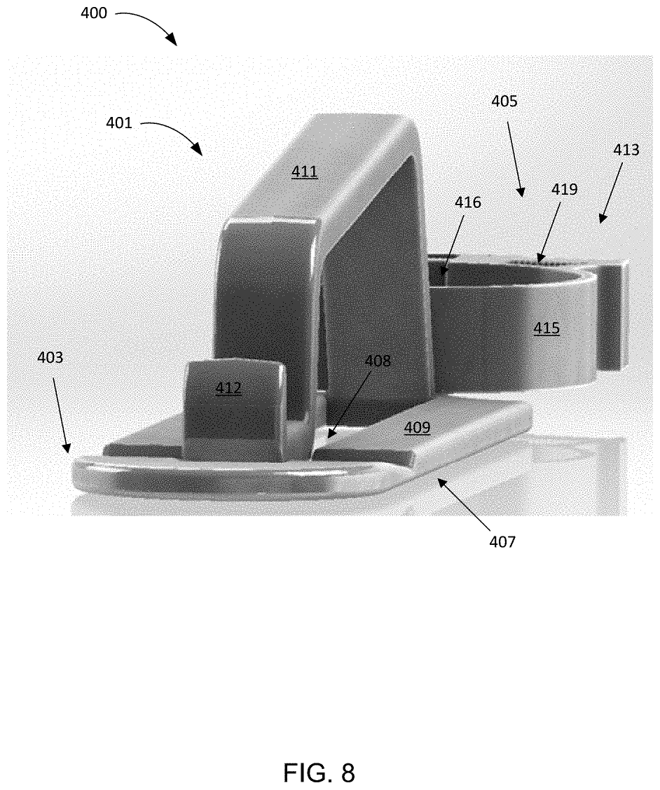

FIG. 4 illustrates a perspective view of an example lighting attachment apparatus 400 in accordance with various embodiments of the present disclosure. FIG. 5 illustrates a profile view of an example lighting attachment apparatus 400 in accordance with various embodiments of the present disclosure. FIG. 6 illustrates an end view of an example lighting attachment apparatus 400 in accordance with various embodiments of the present disclosure. FIG. 7 illustrates another end view of an example lighting attachment apparatus 400 in accordance with various embodiments of the present disclosure. FIG. 8 illustrates a side perspective view of an example lighting attachment apparatus 400 in accordance with various embodiments of the present disclosure. The lighting attachment apparatus 400 may include one or more same or similar features of the lighting attachment apparatus 100 illustrated in FIGS. 1 and 2 or may include one or more same or similar features of the lighting attachment system 300 illustrated in FIG. 3. The lighting attachment apparatus 400 may be for coupling a light bulb receiver to a structure (e.g., a building, a tent, a stand, a handheld object). For example, the lighting attachment apparatus 400 may secure a light bulb receiver of a plurality of light bulb receivers coupled along a chain or a strand of electrical wiring to a roof line, on a roof, or along a rain gutter of a structure for Christmas or holiday lighting. As another example, the lighting attachment apparatus 400 may secure a single light bulb receiver (e.g., a flashlight body) to a location on a tent to provide temporary lighting within or near the tent. As yet another example, the lighting attachment apparatus 400 may secure a light bulb receiver to a camera or a stand to provide moveable lighting for photography or a display.

As shown in at least FIG. 4, the lighting attachment apparatus 400 may generally include a body 401 having a proximal end 403 and a distal end 405. The body 401 may generally have an elongated shape with the proximal end 403 and the distal end 405 positioned 180 degrees from each other about an axis. The elongated shape of the body 401 may also have a first distance from the proximal end 403 to the distal end 405 of the body 401 is greater than a second distance across the body 401 that is perpendicular to the first distance providing the body 401 with the elongated shape. The lighting attachment apparatus 400 may include one or more components made of a flexible elastic plastic, metal, composite, or the like.

An attachment member 407 may be disposed at the proximal end 403 of the body 401. The attachment member 407 may be for attaching the body 401 to a structure (e.g., a building, a tent, a stand, a handheld object) to maintain a position or an orientation of the lighting attachment apparatus 400. In certain embodiments, the attachment member 407 may include an elongated member 409. The elongated member 409 may be inserted against a surface or between two surfaces to maintain the body 401 in a position or an orientation. For example, the elongated member 409 may be positioned between two anchored walls and provide a force against a surface of each of the two anchored wall so that the attachment member 407 maintains a position or an orientation of the lighting attachment apparatus 400. In certain embodiments, the elongated member 409 may be a flat elongated member or a have at least a portion of a length that is flat. In this case, the elongated member 409 may be inserted between two narrowly-spaced structures or between to roof shingles to maintain the body 401 in a position or an orientation.

In certain embodiments, the attachment member 407 may include an attachment arm 411 having a hook 412 disposed at an end of the attachment arm 411 (e.g., opposite the distal end 405 of the body 401). The attachment arm 411 may extend so that the hook 412 at the end of the attachment arm 411 may wrap around or over a lip, a ledge, or an attachment point (e.g., a rope, a string, a loop) of a structure to hang or maintain the body 401 in a position or an orientation. While FIG. 4 illustrates that the hook 412 includes two turning points, the hook 412 may be include less turning points or additional turning points to hook the attachment member 407 over a lip, a ledge, or an attachment point of a structure. Additionally, or alternatively, the hook 412 may be rounded to hook the attachment member 407 over a lip, a ledge, or an attachment point of a structure.

In certain embodiments, the attachment member 407 may include both the elongated member 409 and the attachment arm 411. The elongated member 409 may include an aperture 408 providing a through-hole through at least a portion of the elongated member 409. The attachment arm 411 may be a flexible clamp that in a resting position may have an end that extends at least partially into or partially through the aperture 408. The end of the flexible clamp may be moved into a tension position out of the aperture 408 and away from the elongated member 409 providing a gap between the end of the flexible clamp (e.g., and a portion of the length of the flexible clamp) and the elongated member 409. A wall of a structure (e.g., a wall of a rain gutter) or a roof shingle may be inserted into the gap between the elongated member 409 and the flexible clamp. The flexible clamp may be released from the tension position allowing the flexible clamp to return to the resting position so that the end of the flexible clamp (e.g., and a portion of the length of the flexible clamp) engages the wall of the structure or the roof shingle to exert a clasping force on the wall of the structure or the roof shingle and the elongated member 409 by the flexible clamp.

The lighting attachment apparatus 400 also includes a light bulb receiver coupling member 413. A light bulb receiver may be a light bulb socket or a housing of a light bulb socket that secures a light bulb and couples the light bulb to an electrical power source to illuminate the light bulb. The light bulb receiver coupling member 413 may be disposed at the distal end 405 of the body 401 of the lighting attachment apparatus 400. The light bulb receiver coupling member 413 may engage with and attach a light bulb receiver to the lighting attachment apparatus 400.

The light bulb receiver coupling member 413 may include a first arm 415 and a second arm 417 that each extend from the attachment member 407. The first arm 415 and the second arm 417 may be positioned so that a gap 416 is formed between them. Each of the first arm 415 and the second arm 417 may be moved or flexed from a resting position toward each other into a tension position. In certain embodiments, the first arm 415 may be moved from the resting position to engage a first surface of the light bulb receiver and the second arm 417 may be moved from the resting position to engage a second surface of the light bulb receiver opposite the first surface of the light bulb receiver.

A first set of teeth 419 may be disposed along a length of a surface at an end of the first arm 415. A second set of teeth 421 may be disposed along a length of a surface at an end of the second arm 417. The first arm 415 and the second arm 417 may each have a turning point so that the end of the first arm 415 having the first set of teeth 419 and the end of the second arm 417 have the second set of teeth 421 extend toward each other. In certain embodiments, the first arm 415 and the second arm 417 may each have a curvature so that the end of the first arm 415 having the first set of teeth 419 and the end of the second arm 417 have the second set of teeth 421 extend toward each other.

When the first arm 415 and the second arm 417 are moved from the resting positions towards the tension positions, the first set of teeth 419 may engage the second set of teeth 421 to hold the first arm 415 and the second arm 417 in tension positions. For example, the first arm 415 and the second arm 417 may be moved from the resting positions towards the tension positions so that a first tooth of the first set of teeth 419 cinches or ratchets over and engages a first tooth of the second set of teeth 421 to hold the first arm 415 and the second arm 417 in a first tension position. In another example, the first arm 415 and the second arm 417 may be further moved away from the resting positions and towards the tension positions so that two or more teeth of the first set of teeth 419 may cinch or ratchet over and engage two or more teeth of the second set of teeth 421 to hold the first arm 415 and the second arm 417 in multiple different tension positions and to maintain different distances between the first arm 415 and the second arm 417. Thus, the light bulb receiver coupling member 413 may couple different light bulb receivers having different thicknesses or diameters to the body 401 of the lighting attachment apparatus 400 by adjusting the number of teeth from the first set of teeth 419 that cinch or ratchet over and engage teeth from the second set of teeth 421 and varying the size, diameter, or distance of the gap 416. In addition, the first arm 415 and the second arm 417 may apply greater amounts of force to the first surface of the light bulb receiver and the second surface of the light bulb receiver, respectively, by adjusting the number of teeth from the first set of teeth 419 that cinch or ratchet over and engage teeth from the second set of teeth 421.

In certain embodiments, each of the one or more teeth from the first set of teeth 419 and each of the one or more teeth from the second set of teeth 421 may be shaped or angled. The shape or angle of each of the teeth may permit a tooth from the first set of teeth 419 to cinch or ratchet over and engage a tooth from the second set of teeth 421 when the first arm 415 and the second arm 417 move away from the resting positions towards tension positions (e.g., when the end of the first arm 415 moves towards the end of the second arm 417). Conversely, the shape or angle of each of the teeth may prevent a tooth from the first set of teeth 419 from cinching or ratcheting over a tooth from the second set of teeth 421 and may prevent disengagement of the first set of teeth 419 from the second set of teeth 421 when a force is exerted on the first arm 415 or the second arm 417 towards the resting positions. Thus, in certain embodiments, the first arm 415 or the second arm 417 may be misaligned from the other or moved so that peaks of one or more teeth from the first set of teeth 419 slide along or through troughs of one or more teeth from the second set of teeth 421 and peaks of one or more teeth from the second set of teeth 421 slide along or through troughs of one or more teeth from the first set of teeth 419 to release engagement between the first set of teeth 419 and the second set of teeth 421. Upon release of engagement between the first set of teeth 419 and the second set of teeth 421, the first arm 415 and the second arm 417 may each return to their respective resting positions.

In certain embodiments, the first arm 415 may include a first tooth clamp 423 and the second arm 417 may include a second tooth clamp 425. When one or more teeth of the first set of teeth 419 cinch or ratchet over and engage one or more teeth of the second set of teeth 421, the first tooth clamp 423 engages a surface of the second arm 417 that is opposite from the second set of teeth 421 for forcing the one or more teeth from the second set of teeth 421 against the one or more teeth from the first set of teeth 419. Similarly, when one or more teeth of the first set of teeth 419 cinch or ratchet over and engage one or more teeth of the second set of teeth 421, the second tooth clamp 425 engages a surface of the first arm 415 that is opposite from the first set of teeth 419 for forcing the one or more teeth from the first set of teeth 419 against the one or more teeth from the second set of teeth 421. The first tooth clamp 423 and the second tooth clamp 425 may each further prevent disengagement of the first set of teeth 419 from the second set of teeth 421 when a force is exerted on the first arm 415 or the second arm 417 towards the resting positions.

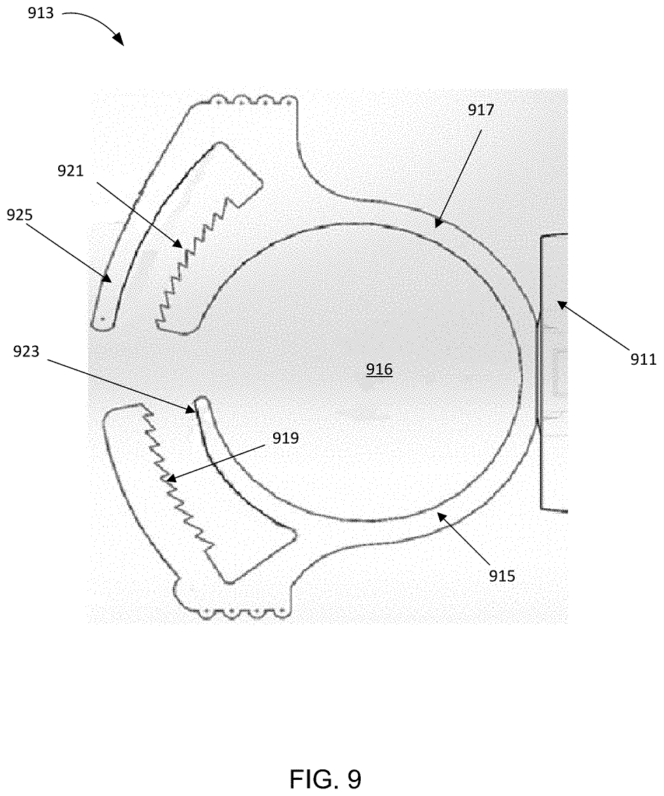

FIG. 9 illustrates a perspective view of an example light bulb receiver coupling member 913 of a lighting attachment apparatus in accordance with various embodiments of the present disclosure. The light bulb receiver coupling member 913 may be the same as or similar to the light bulb receiver coupling member 113 illustrated in FIGS. 1 and 2 and may include one or more same or similar features of the light bulb receiver coupling member 113 illustrated in FIGS. 1 and 2. The light bulb receiver coupling member 913 may be the same as or similar to the light bulb receiver coupling member 313 illustrated in FIG. 3 and may include one or more same or similar features of the light bulb receiver coupling member 313 illustrated in FIG. 3. The light bulb receiver coupling member 913 may be the same as or similar to the light bulb receiver coupling member 413 illustrated in FIGS. 4, 5, 6, 7, and 8 and may include one or more same or similar features of the light bulb receiver coupling member 413 illustrated in FIGS. 4, 5, 6, 7, and 8. The light bulb receiver coupling member 913 may be disposed at a distal end of the body of a lighting attachment apparatus as described herein (e.g., the distal end 105 of the body 101 of the lighting attachment apparatus 100 illustrated in FIGS. 1 and 2, the distal end 305 of the body 301 of the lighting attachment apparatus 300 illustrated in FIG. 3, the distal end 405 of the body 401 of the lighting attachment apparatus 400 illustrated in FIGS. 4, 5, 6, 7, and 8). The light bulb receiver coupling member 913 may engage with and attach a light bulb receiver to a lighting attachment apparatus.

In certain embodiments, the light bulb receiver coupling member 913 may include a first arm 915 and a second arm 917 that each extend from an attachment member as described herein. The first arm 915 and the second arm 917 may be positioned so that a gap 916 is formed between them. Each of the first arm 915 and the second arm 917 may be moved or flexed from a resting position toward each other into a tension position. In certain embodiments, the first arm 915 may be moved from the resting position to engage a first surface of the light bulb receiver and the second arm 917 may be moved from the resting position to engage a second surface of the light bulb receiver opposite the first surface of the light bulb receiver.

A first set of teeth 919 may be disposed along a length of a surface at an end of the first arm 915. A second set of teeth 921 may be disposed along a length of a surface at an end of the second arm 917. The first arm 915 and the second arm 917 may each have a turning point so that the end of the first arm 915 having the first set of teeth 919 and the end of the second arm 917 have the second set of teeth 921 extend toward each other. In certain embodiments, the first arm 915 and the second arm 917 may each have a curvature so that the end of the first arm 915 having the first set of teeth 919 and the end of the second arm 917 have the second set of teeth 921 extend toward each other.

When the first arm 915 and the second arm 917 are moved from the resting positions towards the tension positions, the first set of teeth 919 may engage the second set of teeth 921 to hold the first arm 915 and the second arm 917 in tension positions. For example, the first arm 915 and the second arm 917 may be moved from the resting positions towards the tension positions so that a first tooth of the first set of teeth 919 cinches or ratchets over and engages a first tooth of the second set of teeth 921 to hold the first arm 915 and the second arm 917 in a first tension position. In another example, the first arm 915 and the second arm 917 may be further moved away from the resting positions and towards the tension positions so that two or more teeth of the first set of teeth 919 may cinch or ratchet over and engage two or more teeth of the second set of teeth 921 to hold the first arm 915 and the second arm 917 in multiple different tension positions and to maintain different distances between the first arm 915 and the second arm 917. Thus, the light bulb receiver coupling member 913 may couple different light bulb receivers having different thicknesses or diameters to a body of a lighting attachment apparatus by adjusting the number of teeth from the first set of teeth 919 that cinch or ratchet over and engage teeth from the second set of teeth 921 and varying the size, diameter, or distance of the gap 916. In addition, the first arm 915 and the second arm 917 may apply greater amounts of force to the first surface of the light bulb receiver and the second surface of the light bulb receiver, respectively, by adjusting the number of teeth from the first set of teeth 919 that cinch or ratchet over and engage teeth from the second set of teeth 921.

In certain embodiments, each of the one or more teeth from the first set of teeth 919 and each of the one or more teeth from the second set of teeth 921 may be shaped or angled. The shape or angle of each of the teeth may permit a tooth from the first set of teeth 919 to cinch or ratchet over and engage a tooth from the second set of teeth 921 when the first arm 915 and the second arm 917 move away from the resting positions towards tension positions (e.g., when the end of the first arm 915 moves towards the end of the second arm 917). Conversely, the shape or angle of each of the teeth may prevent a tooth from the first set of teeth 919 from cinching or ratcheting over a tooth from the second set of teeth 921 and may prevent disengagement of the first set of teeth 919 from the second set of teeth 921 when a force is exerted on the first arm 915 or the second arm 917 towards the resting positions. Thus, in certain embodiments, the first arm 915 or the second arm 917 may be misaligned from the other or moved so that peaks of one or more teeth from the first set of teeth 919 slide along or through troughs of one or more teeth from the second set of teeth 921 and peaks of one or more teeth from the second set of teeth 921 slide along or through troughs of one or more teeth from the first set of teeth 919 to release engagement between the first set of teeth 919 and the second set of teeth 921. Upon release of engagement between the first set of teeth 919 and the second set of teeth 921, the first arm 915 and the second arm 917 may each return to their respective resting positions.

In certain embodiments, the first arm 915 may include a first tooth clamp 923 and the second arm 917 may include a second tooth clamp 925. When one or more teeth of the first set of teeth 919 cinch or ratchet over and engage one or more teeth of the second set of teeth 921, the first tooth clamp 923 engages a surface of the second arm 917 that is opposite from the second set of teeth 921 for forcing the one or more teeth from the second set of teeth 921 against the one or more teeth from the first set of teeth 919. Similarly, when one or more teeth of the first set of teeth 919 cinch or ratchet over and engage one or more teeth of the second set of teeth 921, the second tooth clamp 925 engages a surface of the first arm 915 that is opposite from the first set of teeth 919 for forcing the one or more teeth from the first set of teeth 919 against the one or more teeth from the second set of teeth 921. The first tooth clamp 923 and the second tooth clamp 925 may each further prevent disengagement of the first set of teeth 919 from the second set of teeth 921 when a force is exerted on the first arm 915 or the second arm 917 towards the resting positions. In certain embodiments, the first tooth clamp 923 and the second tooth clamp 925 may each include a first thickness. For example, the first tooth clamp 923 and the second tooth clamp 925 may each include a thickness that is the same as or similar to a thickness of a portion of the first arm 915 or the second arm 917.

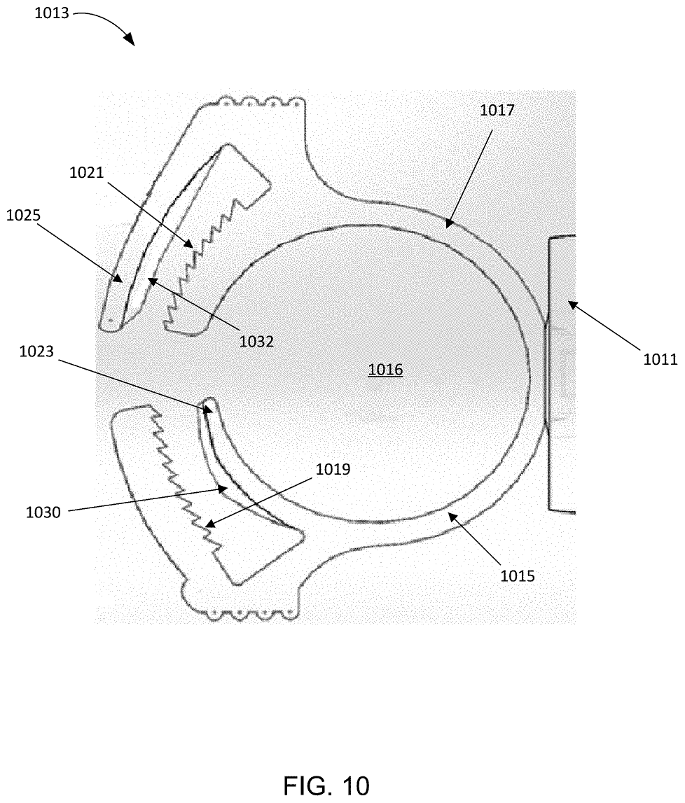

FIG. 10 illustrates a perspective view of another example light bulb receiver coupling member 1013 of a lighting attachment apparatus in accordance with various embodiments of the present disclosure. The light bulb receiver coupling member 1013 may be the same as or similar to the light bulb receiver coupling member 113 illustrated in FIGS. 1 and 2 and may include one or more same or similar features of the light bulb receiver coupling member 113 illustrated in FIGS. 1 and 2. The light bulb receiver coupling member 1013 may be the same as or similar to the light bulb receiver coupling member 313 illustrated in FIG. 3 and may include one or more same or similar features of the light bulb receiver coupling member 313 illustrated in FIG. 3. The light bulb receiver coupling member 1013 may be the same as or similar to the light bulb receiver coupling member 413 illustrated in FIGS. 4, 5, 6, 7, and 8 and may include one or more same or similar features of the light bulb receiver coupling member 413 illustrated in FIGS. 4, 5, 6, 7, and 8. The light bulb receiver coupling member 1013 may be disposed at a distal end of the body of a lighting attachment apparatus as described herein (e.g., the distal end 105 of the body 101 of the lighting attachment apparatus 100 illustrated in FIGS. 1 and 2, the distal end 305 of the body 301 of the lighting attachment apparatus 300 illustrated in FIG. 3, the distal end 405 of the body 401 of the lighting attachment apparatus 400 illustrated in FIGS. 4, 5, 6, 7, and 8). The light bulb receiver coupling member 1013 may engage with and attach a light bulb receiver to a lighting attachment apparatus.

In certain embodiments, the light bulb receiver coupling member 1013 may include a first arm 1015 and a second arm 1017 that each extend from an attachment member as described herein. The first arm 1015 and the second arm 917 may be positioned so that a gap 1016 is formed between them. Each of the first arm 1015 and the second arm 1017 may be moved or flexed from a resting position toward each other into a tension position. In certain embodiments, the first arm 1015 may be moved from the resting position to engage a first surface of the light bulb receiver and the second arm 1017 may be moved from the resting position to engage a second surface of the light bulb receiver opposite the first surface of the light bulb receiver.

A first set of teeth 1019 may be disposed along a length of a surface at an end of the first arm 1015. A second set of teeth 1021 may be disposed along a length of a surface at an end of the second arm 1017. The first arm 1015 and the second arm 1017 may each have a turning point so that the end of the first arm 1015 having the first set of teeth 1019 and the end of the second arm 1017 have the second set of teeth 1021 extend toward each other. In certain embodiments, the first arm 1015 and the second arm 1017 may each have a curvature so that the end of the first arm 1015 having the first set of teeth 1019 and the end of the second arm 1017 have the second set of teeth 1021 extend toward each other.

When the first arm 1015 and the second arm 1017 are moved from the resting positions towards the tension positions, the first set of teeth 1019 may engage the second set of teeth 1021 to hold the first arm 1015 and the second arm 1017 in tension positions. For example, the first arm 1015 and the second arm 1017 may be moved from the resting positions towards the tension positions so that a first tooth of the first set of teeth 1019 cinches or ratchets over and engages a first tooth of the second set of teeth 1021 to hold the first arm 1015 and the second arm 1017 in a first tension position. In another example, the first arm 1015 and the second arm 1017 may be further moved away from the resting positions and towards the tension positions so that two or more teeth of the first set of teeth 1019 may cinch or ratchet over and engage two or more teeth of the second set of teeth 1021 to hold the first arm 1015 and the second arm 1017 in multiple different tension positions and to maintain different distances between the first arm 1015 and the second arm 1017. Thus, the light bulb receiver coupling member 1013 may couple different light bulb receivers having different thicknesses or diameters to a body of a lighting attachment apparatus by adjusting the number of teeth from the first set of teeth 1019 that cinch or ratchet over and engage teeth from the second set of teeth 1021 and varying the size, diameter, or distance of the gap 1016. In addition, the first arm 1015 and the second arm 1017 may apply greater amounts of force to the first surface of the light bulb receiver and the second surface of the light bulb receiver, respectively, by adjusting the number of teeth from the first set of teeth 1019 that cinch or ratchet over and engage teeth from the second set of teeth 1021.

In certain embodiments, each of the one or more teeth from the first set of teeth 1019 and each of the one or more teeth from the second set of teeth 1021 may be shaped or angled. The shape or angle of each of the teeth may permit a tooth from the first set of teeth 1019 to cinch or ratchet over and engage a tooth from the second set of teeth 1021 when the first arm 1015 and the second arm 1017 move away from the resting positions towards tension positions (e.g., when the end of the first arm 1015 moves towards the end of the second arm 1017). Conversely, the shape or angle of each of the teeth may prevent a tooth from the first set of teeth 1019 from cinching or ratcheting over a tooth from the second set of teeth 1021 and may prevent disengagement of the first set of teeth 1019 from the second set of teeth 1021 when a force is exerted on the first arm 1015 or the second arm 1017 towards the resting positions. Thus, in certain embodiments, the first arm 1015 or the second arm 1017 may be misaligned from the other or moved so that peaks of one or more teeth from the first set of teeth 1019 slide along or through troughs of one or more teeth from the second set of teeth 1021 and peaks of one or more teeth from the second set of teeth 1021 slide along or through troughs of one or more teeth from the first set of teeth 1019 to release engagement between the first set of teeth 1019 and the second set of teeth 1021. Upon release of engagement between the first set of teeth 1019 and the second set of teeth 1021, the first arm 1015 and the second arm 1017 may each return to their respective resting positions.

In certain embodiments, the first arm 1015 may include a first tooth clamp 1023 and the second arm 1017 may include a second tooth clamp 1025. When one or more teeth of the first set of teeth 1019 cinch or ratchet over and engage one or more teeth of the second set of teeth 1021, the first tooth clamp 1023 engages a surface of the second arm 1017 that is opposite from the second set of teeth 1021 for forcing the one or more teeth from the second set of teeth 1021 against the one or more teeth from the first set of teeth 1019. Similarly, when one or more teeth of the first set of teeth 1019 cinch or ratchet over and engage one or more teeth of the second set of teeth 1021, the second tooth clamp 1025 engages a surface of the first arm 1015 that is opposite from the first set of teeth 1019 for forcing the one or more teeth from the first set of teeth 1019 against the one or more teeth from the second set of teeth 1021. The first tooth clamp 1023 and the second tooth clamp 1025 may each further prevent disengagement of the first set of teeth 1019 from the second set of teeth 1021 when a force is exerted on the first arm 1015 or the second arm 1017 towards the resting positions.

In certain embodiments, the first tooth clamp 1023 and the second tooth clamp 1025 may each include a second thickness. The second thickness may be greater than the first thickness of the first tooth clamp 923 and the second tooth clamp 925 illustrated in FIG. 9. For example, the second thickness of the first tooth clamp 1023 and the second tooth clamp 1025 may be greater than a thickness of a portion of the first arm 1015 or the second arm 1017. The second thickness may lessen a distance between a surface of the first tooth clamp 1023 and the first set of teeth 1019 compared a distance between a surface of the first tooth clamp 923 and the first set of teeth 919. Similarly, the second thickness may lessen a distance between a surface of the second tooth clamp 1025 and the second set of teeth 1021 compared a distance between a surface of the second tooth clamp 925 and the second set of teeth 921. In certain embodiments, the second thickness may extend along at least a portion of a length of each of the respective tooth clamps. The greater thickness provided by the second thickness of the first tooth clamp 1023 and the second tooth clamp 1025 may provide added tension for improved engagement between the first set of teeth 1019 and the second set of teeth 1021 at different points along the first tooth clamp 1023 and the second tooth clamp 1025.

In certain embodiments, the second thickness of each of the first tooth clamp 1023 and the second tooth clamp 1025 may be the result of one or more protrusions extending from a tooth clamp toward a set of teeth. For example, as shown in FIG. 10, one or more protrusions 1030 may extend from the first tooth clamp 1023 towards the first set of teeth 1019 and one or more protrusions 1032 may extend from the second tooth clamp 1025 towards the second set of teeth 1021. The one or more protrusions 1030 and 1032 may include a thickening portion of the first tooth clamp 1023 and the second tooth clamp 1025, respectively. Additionally, or alternatively, the one or more protrusions 1030 and 1032 may include one or more bumps, ridges, notches, or the like.

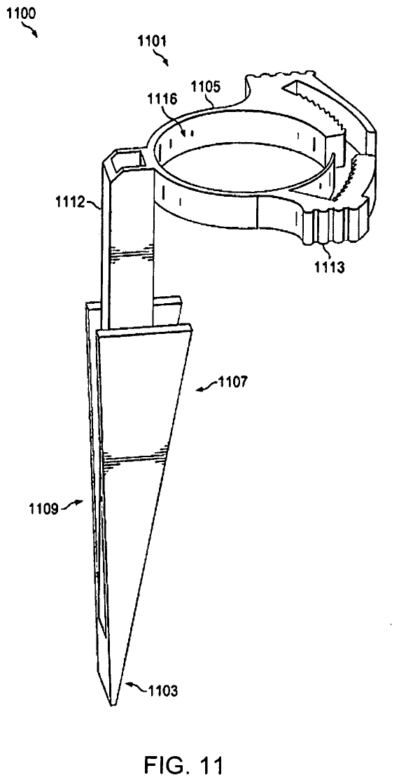

FIG. 11 illustrates a perspective view of another lighting attachment apparatus 1100 in accordance with various embodiments of the present disclosure. The lighting attachment apparatus 1100 may include one or more same or similar features of the lighting attachment apparatus 100 illustrated in FIGS. 1 and 2, one or more same or similar features of the lighting attachment system 300 illustrated in FIG. 3, one or more same or similar features of the lighting attachment apparatus 400 illustrated in FIGS. 4, 5, 6, 7, and 8, or one or more same or similar features described in FIGS. 9 and 10. The lighting attachment apparatus 1100 may be for securing a light bulb receiver to at a particular position on the ground (e.g., in a yard, along a path). For example, the lighting attachment apparatus 1100 may secure a light bulb receiver of a plurality of light bulb receivers coupled along a chain or a strand of electrical wiring to a particular position within a yard to form a design or lighting image with one or more other lighting attachment apparatus 1100 at other positions within the yard. As another example, the lighting attachment apparatus 1100 may secure a light bulb receiver of a plurality of light bulb receivers coupled along a chain or a strand of electrical wiring to a particular position along a path with one or more other lighting attachment apparatus 1100 at other positions along the path to illuminate the path.

As shown in at least FIG. 11, the lighting attachment apparatus 1100 may generally include a body 1101 having a proximal end 1103 and a distal end 1105. The body 1101 may generally have an elongated shape with the proximal end 1103 and the distal end 1105 positioned 180 degrees from each other about an axis. The elongated shape of the body 1101 may also have a first distance from the proximal end 1103 to the distal end 1105 of the body 1101 that is greater than a second distance across the body 1101 that is perpendicular to the first distance providing the body 1101 with the elongated shape. The lighting attachment apparatus 1100 may include one or more components made of a flexible elastic plastic, metal, composite, or the like.

An attachment member 407 may be disposed at the proximal end 403 of the body 401. The attachment member 1107 may be for attaching the body 1101 to a position on or over the ground (e.g., at a position in a yard, at a positon along a path) to maintain that position or orientation of the lighting attachment apparatus 1100. In certain embodiments, the attachment member 1107 may include an elongated member 1109. The elongated member 1109 may be a spike, a stake, or a rod for inserting into the ground to maintain the body 1101 in a particular position or a particular orientation. For example, the elongated member 1109 may be a spike with a pointed portion at the proximal end 1103 of the body 1101 so that the attachment member 1107 may easily inserted into the ground to maintain a position or an orientation of the lighting attachment apparatus 1100 on the ground. In certain embodiments, the elongated member 1109 may be a flat elongated member or a have at least a portion of a length that is flat. In this case, the elongated member 1109 may be inserted at a position within the ground that is as close to a concrete or wood structure as possible to maintain the body 1101 in a particular position or a particular orientation on the ground.

The lighting attachment apparatus 1100 also includes a light bulb receiver coupling member 1113. A light bulb receiver may be a light bulb socket or a housing of a light bulb socket that secures a light bulb and couples the light bulb to an electrical power source to illuminate the light bulb. The light bulb receiver coupling member 1113 may be disposed at the distal end 1105 of the body 1101 of the lighting attachment apparatus 1100. The light bulb receiver coupling member 1113 may engage with and attach a light bulb receiver to the lighting attachment apparatus 1100.

The light bulb receiver coupling member 1113 may include one or more same or similar features and may operate in one or more same or similar manners as other light bulb receiver coupling members described herein. For example, the light bulb receiver coupling member 1113 may be the same as or similar to the light bulb receiver coupling member 113 illustrated in FIGS. 1 and 2 and may include one or more same or similar features of the light bulb receiver coupling member 113 illustrated in FIGS. 1 and 2. As another example, the light bulb receiver coupling member 1113 may be the same as or similar to the light bulb receiver coupling member 313 illustrated in FIG. 3 and may include one or more same or similar features of the light bulb receiver coupling member 313 illustrated in FIG. 3. As yet another example, the light bulb receiver coupling member 1113 may be the same as or similar to the light bulb receiver coupling member 413 illustrated in FIGS. 4, 5, 6, 7, and 8 and may include one or more same or similar features of the light bulb receiver coupling member 413 illustrated in FIGS. 4, 5, 6, 7, and 8. As another example, the light bulb receiver coupling member 1113 may be the same as or similar to the light bulb receiver coupling member 913 illustrated in FIG. 9 and may include one or more same or similar features of the light bulb receiver coupling member 913 illustrated in FIG. 9. As yet another example, the light bulb receiver coupling member 1113 may be the same as or similar to the light bulb receiver coupling member 1013 illustrated in FIG. 10 and may include one or more same or similar features of the light bulb receiver coupling member 1013 illustrated in FIG. 10.

The light attachment apparatus 1100 may also include a coupling member 1112. The coupling member 1112 couples (e.g., fixedly couples, fixedly attaches) the light bulb receiver coupling member 1113 to the attachment member 1107. In certain embodiments and as shown in FIG. 11, the coupling member 1112 may couple the light bulb receiver coupling member 1113 to the attachment member 1107 so that the light bulb receiver coupling member 1113 extends in a perpendicular direction relative to the direction of the attachment member 1107. This configuration would allow for a light bulb secured within the light bulb receiver coupling member 1113 to extend in a direction that is parallel to the direction that the attachment member 1107 extends. In certain embodiments, the coupling member 1112 may couple the light bulb receiver coupling member 1113 to the attachment member 1107 so that the light bulb receiver coupling member 1113 extends in a direction that is parallel to the direction that the attachment member 1107 extends. This configuration would allow for a light bulb secured within the light bulb receiver coupling member 1113 to extend in a direction that is perpendicular to the direction that the attachment member 1107 extends. In certain embodiments, the coupling member 1112 may couple the light bulb receiver coupling member 1113 to the attachment member 1107 so that the light bulb receiver coupling member 1113 extends in a direction that is not parallel or perpendicular to the direction that the attachment member 1107 extends. This configuration would allow for a light bulb secured within the light bulb receiver coupling member 1113 to extend in an angled direction relative to the ground that is neither perpendicular or parallel to the direction that the attachment member 1107 extends.

It may be advantageous to set forth definitions of certain words and phrases used throughout this patent document. The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A lighting attachment apparatus, comprising:
a body having a proximal end and a distal end;
an attachment member disposed at the proximal end of the body for removably attaching the body to a structure; and
a light bulb receiver coupling member disposed at the distal end of the body, wherein the light bulb receiver coupling member comprises:
a first arm for engaging a first side of a light bulb receiver,
a first set of teeth disposed on an end of the first arm,
a second arm for engaging a second side of the light bulb receiver opposite the first side of the light bulb receiver,
a second set of teeth disposed on an end of the second arm and for engaging with the first set of teeth to secure the first arm against the first side of the light bulb receiver and the second arm against the second side of the light bulb receiver.

2. The lighting attachment apparatus of claim 1, wherein the attachment member comprises a flat elongated member for engaging against a roof shingle or a wall of a rain gutter.

3. The lighting attachment apparatus of claim 2, wherein the attachment member comprises a flexible clamp for securely holding the roof shingle against the flat elongated member or for securely holding the wall of the rain gutter against the flat elongated member.

4. The lighting attachment apparatus of claim 1, wherein the first arm comprises a curvature to wrap around the first side of the light bulb receiver, and wherein the second arm comprises a curvature to wrap around the second side of the light bulb receiver.

5. The lighting attachment apparatus of claim 1, wherein the first set of teeth ratchet over the second set of teeth to increase a force applied by the first arm on the first side of the light bulb receiver and to increase a force applied by the second arm on the second side of the light bulb receiver.

6. The lighting attachment apparatus of claim 1, wherein the first set of teeth ratchet over the second set of teeth and increase a number teeth from the first set of teeth that engage with teeth from the second set of teeth.

7. The lighting attachment apparatus of claim 1, wherein the first arm comprises a first tooth clamp to engage a surface of the second arm that is opposite from the second set of teeth for forcing the second set of teeth against the first set of teeth.

8. The lighting attachment apparatus of claim 1, wherein the second arm comprises a second tooth clamp to engage a surface of the first arm that is opposite from the first set of teeth for forcing the first set of teeth against the second set of teeth.

9. The lighting attachment apparatus of claim 1, wherein when the first set of teeth are engaged with the second set of teeth, the first arm and the second are aligned with each other and overlap each other, wherein the first set of teeth and the second set of teeth disengage from each by moving the first arm out of alignment with the second arm so that the first arm does not overlap with the second arm.

10. The lighting attachment apparatus of claim 1, wherein the light bulb receiver coupling member is attached to an elevation member extending from the attachment member.

11. A lighting attachment apparatus, comprising:
a light bulb receiver coupling member including:
a first arm for engaging a first side of a light bulb receiver,
a first set of teeth disposed on an end of the first arm,
a second arm for engaging a second side of the light bulb receiver opposite the first side of the light bulb receiver,
a second set of teeth disposed on an end of the second arm and for engaging with the first set of teeth to secure the first arm against the first side of the light bulb receiver and the second arm against the second side of the light bulb receiver.

12. The lighting attachment apparatus of claim 11, wherein the first arm comprises a curvature to wrap around the first side of the light bulb receiver, and wherein the second arm comprises a curvature to wrap around the second side of the light bulb receiver.

13. The lighting attachment apparatus of claim 11, wherein the first set of teeth ratchet over the second set of teeth to increase a force applied by the first arm on the first side of the light bulb receiver and to increase a force applied by the second arm on the second side of the light bulb receiver.

14. The lighting attachment apparatus of claim 11, wherein the first set of teeth ratchet over the second set of teeth and increase a number teeth from the first set of teeth that engage with teeth from the second set of teeth.

15. The lighting attachment apparatus of claim 11, wherein the first arm comprises a first tooth clamp to engage a surface of the second arm that is opposite from the second set of teeth for forcing the second set of teeth against the first set of teeth.

16. The lighting attachment apparatus of claim 11, wherein the second arm comprises a second tooth clamp to engage a surface of the first arm that is opposite from the first set of teeth for forcing the first set of teeth against the second set of teeth.

17. The lighting attachment apparatus of claim 11, wherein when the first set of teeth are engaged with the second set of teeth, the first arm and the second are aligned with each other and overlap each other, wherein the first set of teeth and the second set of teeth disengage from each by moving the first arm out of alignment with the second arm so that the first arm does not overlap with the second arm.

18. A lighting attachment system, comprising:
a body having a distal end and a proximal end;
an attachment member disposed at the proximal end of the body for removably attaching the body to a structure;
a light bulb receiver configured to receive a light bulb for illumination; and
a light bulb receiver coupling member disposed at the distal end of the body, wherein the light bulb receiver coupling member comprises:
a first arm for engaging a first side of the light bulb receiver,
a first set of teeth disposed on an end of the first arm,
a second arm for engaging a second side of the light bulb receiver opposite the first side of the light bulb receiver,
a second set of teeth disposed on an end of the second arm and for engaging with the first set of teeth to secure the first arm against the first side of the light bulb receiver and the second arm against the second side of the light bulb receiver.

19. The lighting attachment system of claim 18, wherein the light bulb receiver is one light bulb receiver of two or more light bulb receivers electrically coupled to each other via a wired strand.

20. The lighting attachment system of claim 18, wherein the light bulb receiver coupling member is attached to an elevation member extending from the attachment member.
